(19) United States
(12) Patent Application Publication
(10) Pub. No.: US 2016/0162048 A1
(43) Pub. Date: Jun. 9, 2016

(54) USER INTERFACE FOR AN ELECTRONIC STYLUS

(71) Applicant: QUALCOMM Incorporated, San Diego, CA (US)

(72) Inventor: Lior David, Kiriat Ata (IL)

(21) Appl. No.: 14/559,218

(22) Filed: Dec. 3, 2014

(51) Int. Cl. G06F 3/0354

(52) U.S. Cl. CPC G06F 3/03545

(57) ABSTRACT

This disclosure provides systems, methods and apparatus related to an electronic stylus, the stylus having a manual user interface and including a nib and an ultrasonic transmitter configured to transmit an ultrasonic signal. The manual user interface includes one or both of: (i) a removable cap, wherein installing the cap covers the nib and switches the ultrasonic transmitter to a power down mode and removing the cap exposes the nib and switches the ultrasonic transmitter to a power up mode; and (ii) an actuator configured to switch the stylus between a first mode and a second mode, wherein, in the first mode, the nib is in an exposed position and the ultrasonic transmitter is switched to the power up mode; and, in the second mode, the nib is in a covered position and the ultrasonic transmitter is switched to the power down mode.

### TECHNICAL FIELD

This disclosure relates generally to a stylus operable as an electronic user interface with a computing device and including an ultrasonic transmitter, more particularly, an electronic stylus having a manual user interface for switching the ultrasonic transmitter between a power up mode and a power down mode.

### DESCRIPTION OF THE RELATED TECHNOLOGY

An electronic stylus may provide a user interface with a computing device by transmitting ultrasound signals, from which a position and/or orientation of the stylus may be determined by the computing device. The computing device may be, for example, a personal computer, smart phone, tablet, e-reader or other personal electronic device. The electronic stylus may operate as a conventional writing instrument that permits a user to write on paper while also transmitting ultrasound data that is received by a receiver and used to determine the position and/or orientation of the stylus. The ultrasound data may be sampled and/or decoded by the receiver, which may be communicatively coupled with the computing device. The stylus may have a size, weight and form factor similar to a traditional writing instrument such as a pen or pencil.

Generating and transmitting the ultrasound signal requires significant power drain on the stylus which may ordinarily be battery powered. To reduce power drain and lengthen the intervals between battery recharge or replacement, the stylus may detect when a user presses the pen tip onto a surface and stop transmitting (i.e., enter a “power down” or “sleep” mode) if the user does not use the stylus on the surface for a period of time. As a result, after the stylus is in the power down mode, the stylus is not immediately operable. That is, unlike a conventional writing instrument, the user cannot simply and immediately “write” with the device, but instead must press the stylus tip to a surface, to “wake” the stylus (i.e., cause the stylus to enter a “power up” mode). Such a process results in a noticeable latency period that may worsen a user's experience with the stylus.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes a stylus, including a nib, an ultrasonic transmitter configured to transmit an ultrasonic signal, and a manual user interface. The manual user interface includes one or both of (i) a removable cap, installing the cap covers the nib and switches the ultrasonic transmitter to a power down mode wherein removing the cap exposes the nib and switches the ultrasonic transmitter to a power up mode; and (ii) an actuator configured to switch the stylus between a first mode and a second mode, wherein, in the first mode, the nib is in an extended position and the ultrasonic transmitter is switched to the power up mode; and, in the second mode, the nib is in a retracted position and the ultrasonic transmitter is switched to the power down mode.

In some examples, the apparatus may include a micro-switch disposed proximate to an external surface of the stylus, the micro-switch being configured to switch the ultrasonic transmitter between the power up mode and the power down mode. Installing the cap may result in pressing the micro-switch. Installing the cap may result in actuating the micro-switch from a closed position to an open position. Removing the cap may result in releasing the micro-switch from an open position to a closed position.

In some examples, the ultrasonic transmitter may be configured to transmit an ultrasonic signal when the micro-switch is in the closed position irrespective of whether the nib is in contact with a writing surface. In other examples, the ultrasonic transmitter may be configured to transmit an ultrasonic signal when the micro-switch is in the closed position only when the nib is in contact with a writing surface.

In some examples, the actuator may be a manually operated push button.

In some examples, a first press of the push button may urge the nib into the extended position, and cause the ultrasonic transmitter to be switched to the power up mode; and a second press of the push button may cause the nib to return to the retracted position, and causes the ultrasonic transmitter to be switched to the power down mode.

In some examples, the first press of the push button may cause the ultrasonic transmitter to start transmitting an ultrasonic signal irrespective of whether the nib is in contact with a writing surface. In other examples, the first press of the push button causes the ultrasonic transmitter to start transmitting an ultrasonic signal only when the nib is in contact with a writing surface.

In some examples, the apparatus may include a detector arrangement configured to detect an ultrasonic signal emitted by the stylus, the detector arrangement including at least a first acoustic sensor and a second acoustic sensor; and a computing device configured to determine the position of the stylus based on the detected ultrasonic signal.

According to some implementations, where an electronic stylus has a manual user interface and includes an ultrasonic transmitter, a method of operating the electronic stylus includes determining whether the manual user interface has been switched to a ready condition; and switching the ultrasonic transmitter to the power up mode upon determining that the manual user interface has been switched to the ready condition. The manual user interface includes one or both of: a removable cap such that removal of the cap uncovers a nib of the electronic stylus and places the manual user interface in the ready condition, and installation of the cap covers the nib and places the manual user interface in the standby condition; and an actuator configured to switch the manual user interface between the ready condition and the standby condition, such that the actuator, in the ready condition, places the nib is in an extended position; and, in the standby condition, places the nib is in a retracted position.

In some examples, the method may include operating the ultrasonic transmitter in a power up mode, determining whether the manual user interface has been switched to a standby condition, and switching the ultrasonic transmitter to the power down mode upon determining that the manual user interface has been switched to the standby condition.

According to some implementations, an apparatus includes a stylus, the stylus including a nib, an ultrasonic transmitter configured to transmit an ultrasonic signal, and a manual user interface. The manual user interface includes means for switching an ultrasonic transmitter between a power up mode and a power down mode; wherein the manual user interface is switchable between a ready condition and a standby condition, such that when the manual user interface is switched to the ready condition, the nib is exposed and the ultrasonic transmitter is switched to the power up mode; and when the manual user interface is switched to the standby condition, the nib is covered and the ultrasonic transmitter is switched to the power down mode. The apparatus includes means for: determining whether the manual user interface has been switched to the ready condition; and switching the ultrasonic transmitter to the power up mode upon determining that the manual user interface has been switched to the ready condition.

In some examples, the apparatus may include means for operating the ultrasonic transmitter in the power up mode; determining whether the manual user interface has been switched to the standby condition; switching the ultrasonic transmitter to the power down mode upon determining that the manual user interface has been switched to the standby.

In some examples, the manual user interface may include a removable cap, such that installing the cap switches the manual user interface to the standby condition and removing the cap switches the manual user interface to the ready condition. Installing the cap may result in pressing a micro-switch disposed proximate to an external surface of the stylus, the micro-switch being configured to switch the ultrasonic transmitter between the power up mode and the power down mode. Installing the cap may result in actuating the micro-switch from a closed position to an open position; and removing the cap results in releasing the micro-switch from an open position to a closed position.

In some examples, the manual user interface may include an actuator that moves the nib between an exposed position and a covered position and switches the manual user interface between the ready condition and the standby condition. The actuator may be a manually operated push button. A first press of the push button may urge the nib into the extended position, and may cause the ultrasonic transmitter to be switched to the power up mode; and a second press of the push button may cause the nib to return to the retracted position, and may cause the ultrasonic transmitter to be switched to the power down mode.

In some examples, the first press of the push button causes the ultrasonic transmitter to start transmitting an ultrasonic signal irrespective of whether the nib is in contact with a writing surface. In other examples, the first press of the push button causes the ultrasonic transmitter to start transmitting an ultrasonic signal only when the nib is in contact with a writing surface.

According to some implementations, where a non-transitory computer readable medium has software stored thereon, the software including instructions for operating an electronic stylus, the electronic stylus having a manual user interface and including an ultrasonic transmitter, the instructions cause the electronic stylus to: determine whether the manual user interface has been switched to a ready condition; and switch the ultrasonic transmitter to the power up mode upon determining that the manual user interface has been switched to the ready condition. The manual user interface includes one or both of: a removable cap such that removal of the cap uncovers a nib of the electronic stylus and places the manual user interface in the ready condition, and installation of the cap covers the nib and places the manual user interface in the standby condition; and an actuator configured to switch the manual user interface between the ready condition and the standby condition, such that the actuator, in the ready condition, places the nib is in an extended position; and, in the standby condition, places the nib is in a retracted position.

In some examples, the instructions may further cause the electronic stylus to operate the ultrasonic transmitter in a power up mode, determine whether the manual user interface has been switched to a standby condition, and switch the ultrasonic transmitter to the power down mode upon determining that the manual user interface has been switched to the standby condition.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

Like reference numbers and designations in the various drawings indicate like elements.

FIG. 1 show an example of an acoustic sensor system.

FIG. 2 shows an external view of an example electronic stylus.

FIG. 3 shows a block diagram of the example electronic stylus.

FIG. 4A shows an external view of an electronic stylus according to a first implementation.

FIG. 4B shows a simplified block diagram of an electronic stylus according to the first implementation.

FIGS. 5A and 5B show external views of an electronic stylus according to a second implementation.

FIG. 5C shows a block diagram of an electronic stylus according to the second implementation.

FIGS. 6A and 6B show external views of an electronic stylus according to a third implementation.

FIG. 6C shows a block diagram of an electronic stylus according to the third implementation.

FIG. 7 illustrates process flow diagram for operating an electronic stylus, according to some implementations.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system for ultrasonic sensing. In addition, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the figures, but instead have wide applicability as will be readily apparent to one having ordinary skill in the art.

Particular implementations of the subject matter described in this disclosure can be implemented to realize one or more of the following potential advantages. Relative to the prior art, the presently disclosed techniques provide a significantly improved user interface for an electronic stylus. The improved user interface results in a reduction in latency and avoidance of instances of the electronic stylus unexpectedly entering a power down mode, while still permitting battery power drain to be minimized when the electronic stylus is not in use.

The above-described benefits are provided by a manual user interface, configured to be intuitive to the user, whereby an ultrasonic transmitter of the electronic stylus is switched between a power up mode and a power down mode. The power down mode may be a “standby” or “sleep” mode for example. The manual user interface may include a removable cap for the electronic stylus that selectably covers and uncovers a nib of the electronic stylus and/or a pushbutton actuator that selectably extends and retracts the nib. Uncovering and/or extending the nib may cause the ultrasonic transmitter to enter the power up mode, whereas covering and/or retracting the nib causes the ultrasonic transmitter to enter the power down mode. As a result, the user experience is improved because, similarly to a conventional writing instrument, the electronic stylus, in the power up mode, is ready for instant use when the nib is visible, whether or not the nib is in contact with a writing surface.

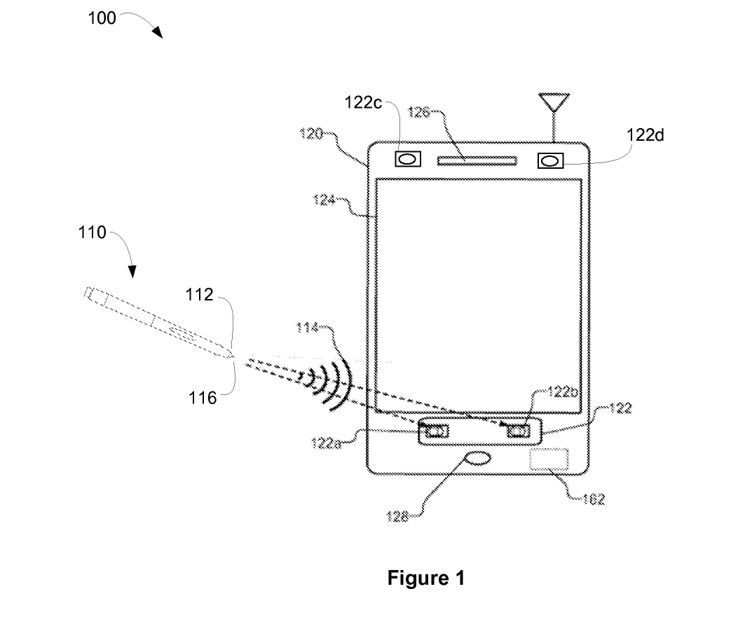

FIG. 1 shows an example of an acoustic sensor system with which the described implementations may be used. The acoustic sensor system 100 operates in the ultrasonic range, and is therefore sometimes referred to as an “ultrasonic system”. However, it should be understood that the present disclosure may be applicable to systems that operated outside of the ultrasound range. The ultrasonic system 100 is illustrated as including an electronic stylus 110 that is communicatively coupled with a receiver device 120. The electronic stylus 110 includes an ultrasonic transmitter 112 that emits acoustic signals 114. The ultrasonic transmitter 112 may be disposed proximate to a nib 116. The nib 116 may include a point or tip of the electronic stylus 110, located proximate to a distal end of the electronic stylus 110. The receiver device 120 includes an acoustic (ultrasonic) receiver 122. The acoustic receiver 122 may include and/or be communicatively coupled with microphones. In the illustrated implementation, four microphones, identified as microphone 122a, microphone 122b, microphone 122c, and microphone 122d are shown, but additional or fewer microphones may be provided, if desired. The receiver device 120 may include a CODEC 162 (or multiple CODECs) for sampling and decoding acoustic signals received by acoustic receiver 122. The electronic stylus 110 is illustrated as being in the form of a conventional writing instrument, and may also function as such a writing instrument. In some implementations, the electronic stylus 110 may include a refill including one or both of an ink supply or a pencil lead dispenser. It should be understood, however, that the electronic stylus 110 may also be operable whether or not the nib 116 is in physical contact with a writing surface. In some implementations, for example, the electronic stylus 110 may be used for gesture recognition and/or wide-area 3D positioning, in which applications there may be no physical contact between the nib 116 and any surface for extended periods of time.

In the illustrated implementation, the receiver device 120 may be a mobile platform, such as a cellular telephone or smartphone, including a display 124, which may be a touch screen display, as well as a speaker 126 and a microphone 128, which is illustrated as being separate from but may be part of the ultrasonic receiver 122. While the illustrated receiver device 120 is suggestive of a cellular telephone, it should be understood that the receiver device 120 may be any desired electronic device, including a portable computer, such as a laptop, notebook, or tablet type computer, or other similar devices, such as an e-book reader or personal communication system (PCS) device, personal navigation device (PND), Personal Information Manager (PIM), Personal Digital Assistant (PDA), or other suitable devices.

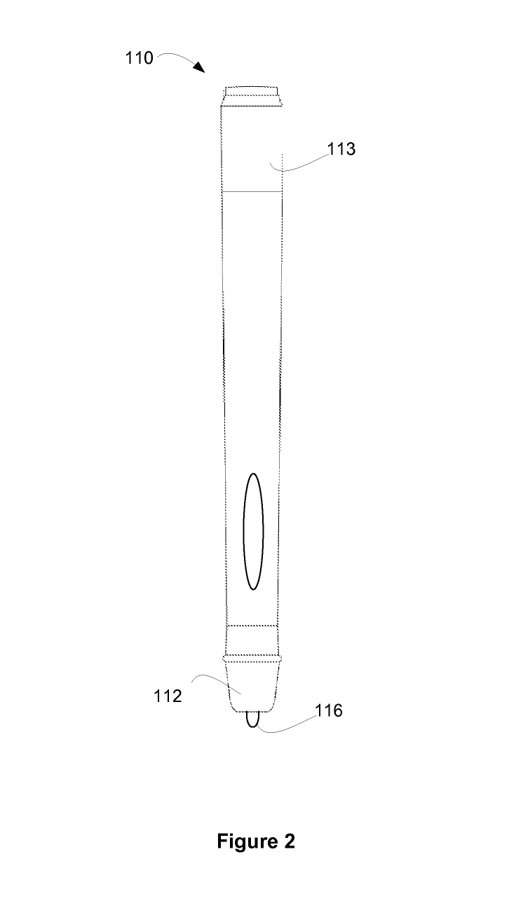

FIG. 2 show an external view of an example electronic stylus. The electronic stylus 110 may be employed as part the acoustic sensor system illustrated in FIG. 1. The electronic stylus 110 includes the nib 116 and the ultrasonic transmitter 112. The ultrasonic transmitter may be disposed within a protective enclosure and be proximate to or approximately co-located with the nib 116 at or near the distal end of the electronic stylus 110. When, as illustrated in FIG. 2, the nib 116 is exposed, the electronic stylus 110 may be operable to write, on paper or other writing surface, using ink, or any other writing medium such as pencil graphite. When the ultrasonic transmitter 112 is in a power up mode, the ultrasonic transmitter 112 may be configured to transmit an acoustic signal from which a location of the ultrasonic transmitter 112 may be determined by the receiver device 120. In some implementations, an additional transmitter 113 may be disposed near a proximal end of the electronic stylus 110, thereby enabling relative positions of the distal and proximal ends of the stylus to be determined by the receiver device 120.

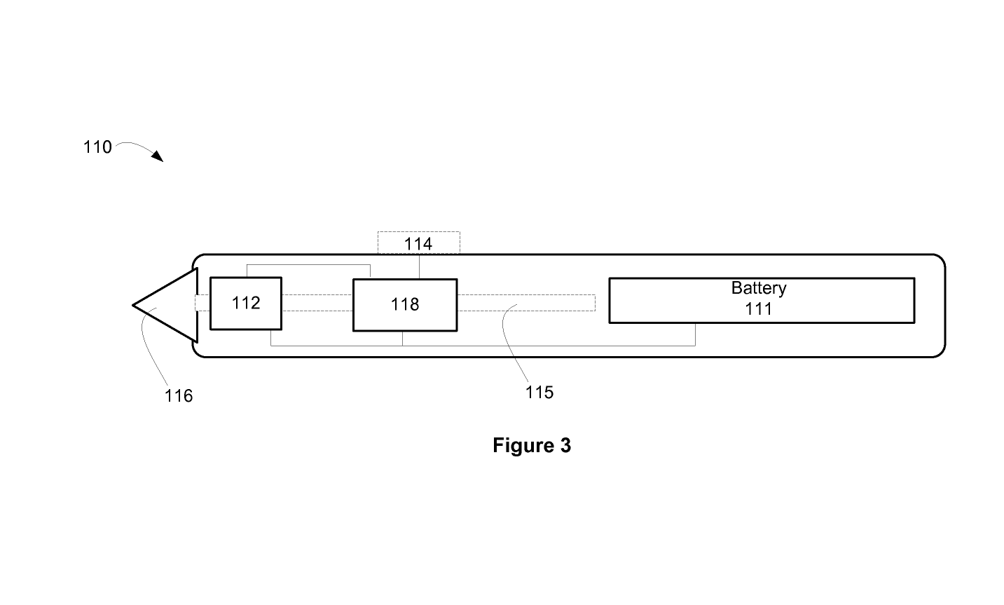

FIG. 3 show a block diagram of the example electronic stylus 110. As indicated above, the electronic stylus 110 includes the nib 116 and the ultrasonic transmitter 112. The ultrasonic transmitter 112 is communicatively coupled with a controller 118. A battery 111 provides power to the controller 118 and/or the ultrasonic transmitter 112.

The electronic stylus 110 may optionally include a switch 114. The switch may be provided for any of a range of functions or may simply provide a signal whose purpose is decided by the operating system or application to which the signals are eventually submitted. For example, in some known devices, the switch 114 may be operable manually and may be actuated by a user to change a color of lines to be traced out on the display 124, or in place of mouse clicks, or for shooting in games.

The electronic stylus 110 may also optionally include a refill 115. The refill 115 may include, for example, an ink supply and/or a pencil lead dispenser.

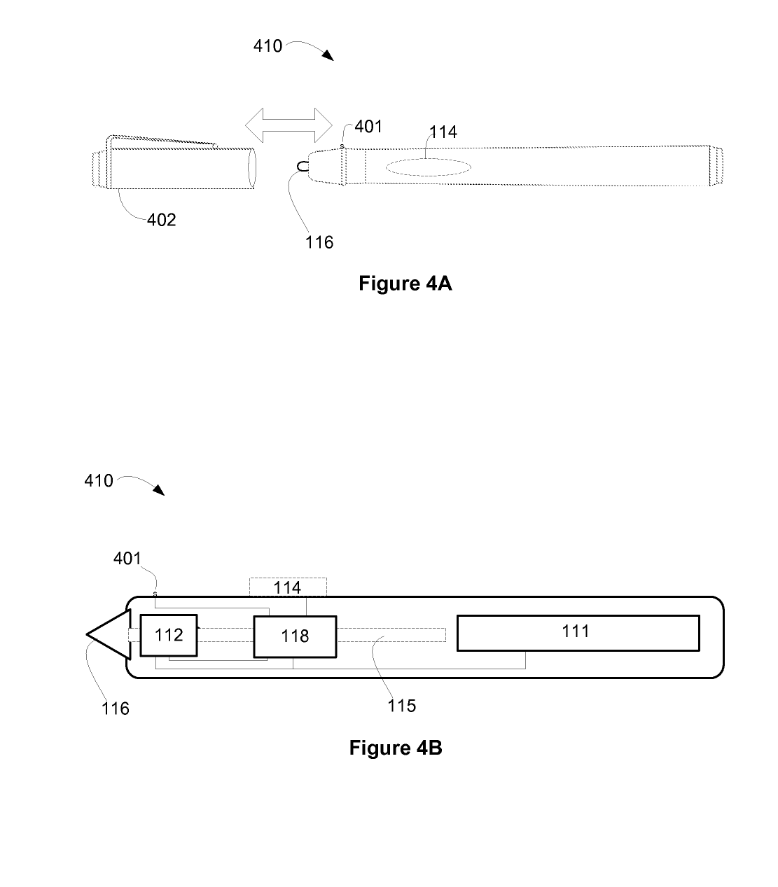

FIG. 4A shows an external view of an electronic stylus 410 according to a first implementation. FIG. 4B illustrates a simplified block diagram of the electronic stylus 410. Referring first to FIG. 4A, in the illustrated implementation, the electronic stylus 410 includes a switch 401 that may be actuated by installation and removal of a stylus cap 402. Stylus cap 402 may be configured to have a size and form factor similar to a cap of conventional writing instrument and to slidably engage with the electronic stylus 410. The stylus cap 402 may be configured to have an internal diameter that is close to an outer diameter of the electronic stylus 410. The switch 401 may be small relative to the switch 114, and be sensitive to small motions. Indicative of these features, the switch 401 may be referred to as a “micro-switch” 401.

The stylus cap 402 and the micro-switch 401 may be configured such that removing the cap 402 from the electronic stylus 410 results in a first actuation of the micro-switch 401, which results in switching the ultrasonic transmitter 112 (FIG. 4B) to a power up mode. Further, the stylus cap 402 and the micro-switch 401 may be configured such that installing the stylus cap 402 covers the nib 116 and results in a second actuation of micro-switch 401, which results in switching the ultrasonic transmitter 112 to a power down mode. As a result of the above disclosed configuration, a user may operate electronic stylus in a manner closely resembling that of a conventional writing instrument. More particularly, in some implementations, the user simply removes the stylus cap 402 and the ultrasonic transmitter 112 of electronic stylus 410 will be nearly immediately operational whether or not the nib 116 is in contact with a writing surface. In some implementations, the ultrasonic transmitter 112 may remain in the power up mode until such time as the user reinstalls the stylus 402. In other implementations, the ultrasonic transmitter 112 may be returned to the power down mode after a period of time. The period of time, may be set by the stylus manufacturer or by the user. The period of time may be set once and/or may be resettable at the user's discretion.

In the illustrated implementation, the micro-switch 401 is disposed proximate to an external surface of the stylus such that it may be engaged by the stylus cap 402. In some implementations, installing the stylus cap 402 may result in pressing the micro-switch 401 from a closed position to an open position, whereas removing the stylus cap 402 may result in releasing the micro-switch 401 from the open position to the closed position. In some implementations, the ultrasonic transmitter may transmit an ultrasonic signal when the micro-switch is in the closed position irrespective of whether the nib is in contact with a writing surface. Alternatively, the ultrasonic transmitter may transmit an ultrasonic signal when the micro-switch is in the closed position only when the nib is in contact with a writing surface. It will be appreciated that the micro-switch 401 may be configured and/or located in a variety of ways. Optionally, the electronic stylus 410 may include the switch 114 described above in addition to micro-switch 401.

Referring now to FIG. 4B, it is shown that the micro-switch 401 may be communicatively coupled with the controller 118. Responsive to an actuation of the micro-switch 401, the controller 118 may cause the ultrasonic transmitter 112 to switch between the power up mode and the power down mode. In some implementations (not illustrated) the micro-switch 401 may be communicatively coupled directly with ultrasonic transmitter 112, alternatively or in addition to the controller 118. Optionally, the stylus 410 may include the refill 115.

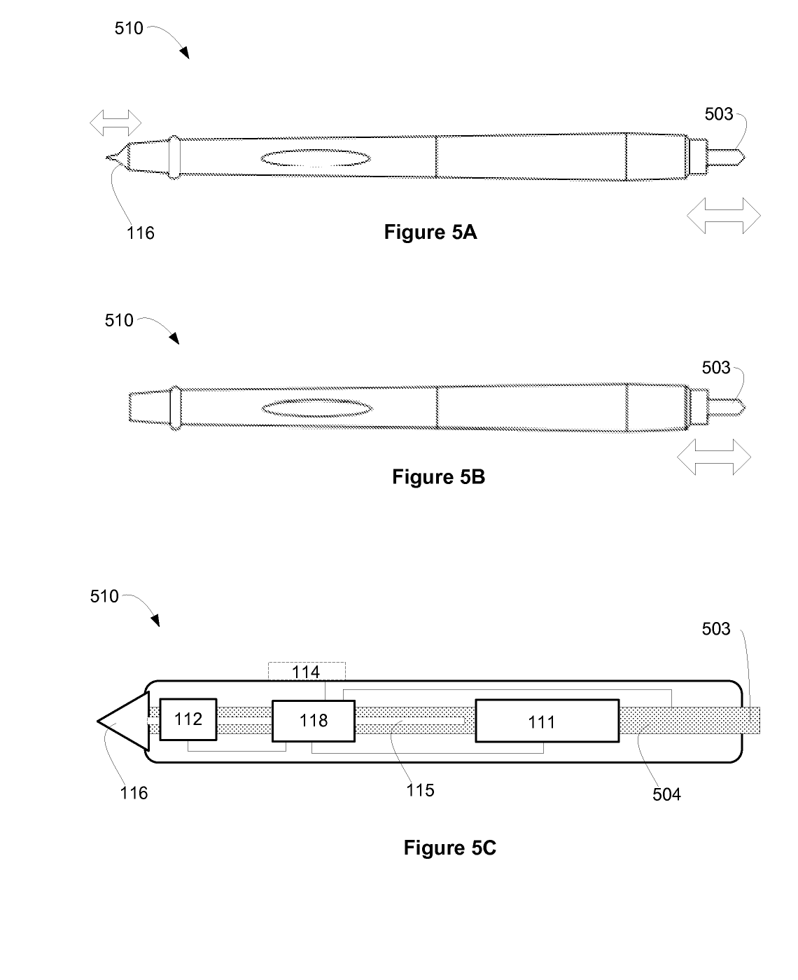

FIGS. 5A and 5B show external views of an electronic stylus 510 according to a second implementation. FIG. 5C illustrates a simplified block diagram of the electronic stylus 510. Referring first to FIGS. 5A and 5B, in the illustrated implementation, the electronic stylus 510 includes a pushbutton actuator 503 that may be manually actuated in order to extend or retract the nib 116. FIG. 5A shows the electronic stylus 510 configured in a first mode, in which the nib 116 is in an extended position. FIG. 5B shows the electronic stylus configured in a second mode, in which the nib 116 is a retracted position. The pushbutton actuator 503 may be configured to have a size and form factor similar to a traditional actuator of a retractable ball point pen or mechanical pencil, for example.

Referring now to FIG. 5C, it is shown that the pushbutton actuator 503 may be communicatively coupled with the controller 118. Responsive to an actuation of the pushbutton actuator 503, the controller 118 may cause the ultrasonic transmitter 112 to switch between the power up mode and the power down mode. More particularly, when the pushbutton actuator 503 has switched the electronic stylus to the first mode (FIG. 5A), nib 116 is in the extended position, and the pushbutton actuator 503 may also cause the ultrasonic transmitter 112 to be switched to the power up mode. When the pushbutton actuator 503 has switched the electronic stylus to the second mode (FIG. 5B), nib 116 is in the retracted position, and the pushbutton actuator 503 may also cause the ultrasonic transmitter 112 to be switched to the power down mode.

Optionally, the stylus 410 may include the refill 115. In the illustrated implementation, whether or not the stylus 510 includes the refill 115, the pushbutton actuator 503 is mechanically or electromechanically coupled with nib 116 by a linkage 504, such that a first press of the pushbutton actuator 503 urges the nib 116 into the extended position (FIG. 5A) whereas a second press of the pushbutton actuator 503 causes the nib 116 to return to the refracted position (FIG. 5B).

Referring again to FIG. 5C, it is shown that the pushbutton actuator 503 may be communicatively coupled with the controller 118. Responsive to an actuation of the pushbutton actuator 503, the controller 118 may cause the ultrasonic transmitter 112 to switch between the power up mode and the power down mode. In some implementations (not illustrated) the pushbutton actuator 503 may be communicatively coupled directly with ultrasonic transmitter 112, alternatively or in addition to the controller 118.

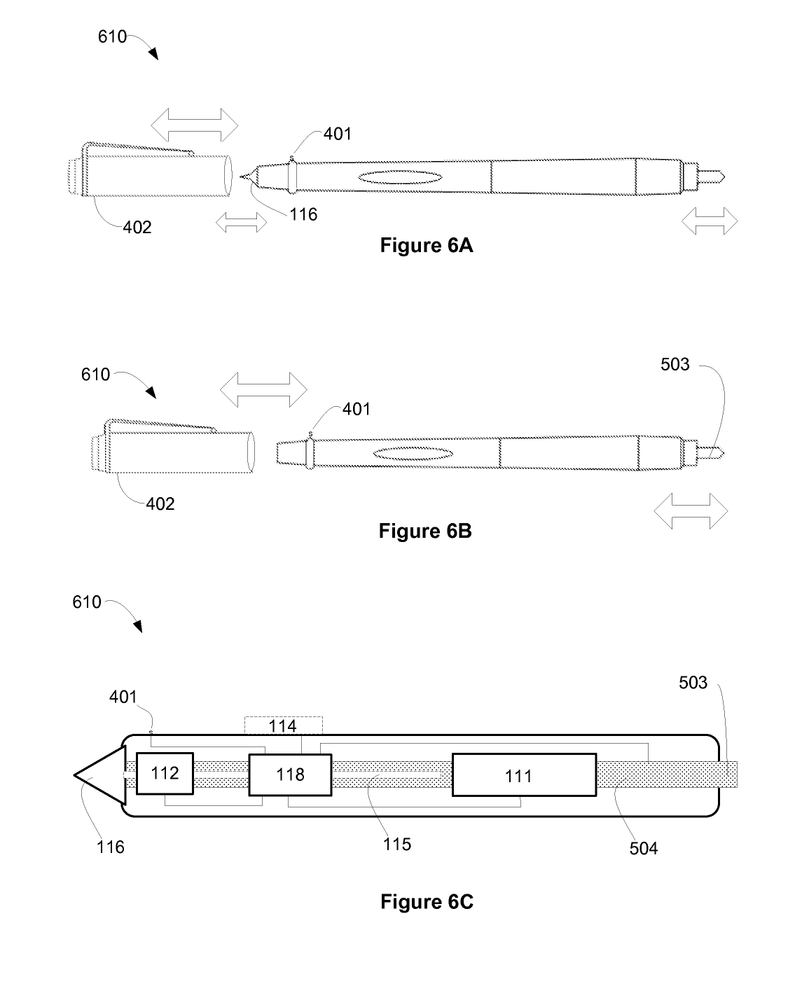

FIGS. 6A and 6B show external views of an electronic stylus 610 according to a third implementation. FIG. 6C illustrates a simplified block diagram of the electronic stylus 610. Referring first to FIGS. 6A and 6B, in the illustrated implementation, the electronic stylus 610 includes the switch 401 that may be actuated by installation and removal of the stylus cap 402 as well as the pushbutton actuator 503 that may be manually actuated in order to extend or retract the nib 116. FIG. 6A shows the electronic stylus 610 configured in the first mode, in which the nib 116 is the extended position. FIG. 6B shows the electronic stylus 610 configured in the second mode, in which the nib 116 is the retracted position. Irrespective of whether the electronic stylus 610 is in the first mode or in the second mode, the stylus cap 402 may be installed or removed.

Referring now to FIG. 6C, it is shown that the micro-switch 401 and the pushbutton actuator 503 may each be communicatively coupled with the controller 118. Responsive to an actuation of the micro-switch 401 and/or the pushbutton actuator 503, the controller 118 may cause the ultrasonic transmitter 112 to switch between the power up mode and the power down mode.

For example, in some implementations, when the pushbutton actuator 503 has switched the electronic stylus to the first mode (FIG. 5A), nib 116 is in the extended (“exposed”) position, the pushbutton actuator 503 may also cause the ultrasonic transmitter 112 to be switched to the power up mode irrespective of whether the stylus cap 402 is installed or is removed. In other implementations the pushbutton actuator 503 may cause the ultrasonic transmitter 112 to be switched to the power up mode only when the stylus cap 402 has been removed. When the pushbutton actuator 503 has switched the electronic stylus 610 to the second mode (FIG. 6B), the nib 116 is in the retracted position and the pushbutton actuator 503 may also cause the ultrasonic transmitter 112 to be switched to the power down mode irrespective of whether the stylus cap 402 is installed or is removed.

Referring again to FIG. 6C, it is shown that the micro-switch 401 and the pushbutton actuator 503 may be communicatively coupled with the controller 118. Responsive to an actuation of one or both of the micro-switch 401 and the pushbutton actuator 503, the controller 118 may cause the ultrasonic transmitter 112 to switch between the power up mode and the power down mode. In some implementations (not illustrated), one or more of the micro-switch 401 and the pushbutton actuator 503 may be communicatively coupled directly with the ultrasonic transmitter 112, alternatively or in addition to the controller 118.

According to the above-described implementations, an electronic stylus is configured to switch its ultrasonic transmitter between a power up mode and a power down mode in a manner that depends upon a condition of the manual user interface. More particularly, for example, in configurations where the manual user interface includes the stylus cap 402, the manual user interface may be said to be in a standby condition when the stylus cap 402 is installed and may be said to be in a ready condition when the stylus cap 402 is removed. In configurations where the manual user interface is the pushbutton actuator 503, the manual user interface may be said to be in the standby condition when the pushbutton actuator 503 has caused the nib 116 to retract and may be said to be in the ready condition when the pushbutton actuator 503 has caused the nib 116 to be exposed.

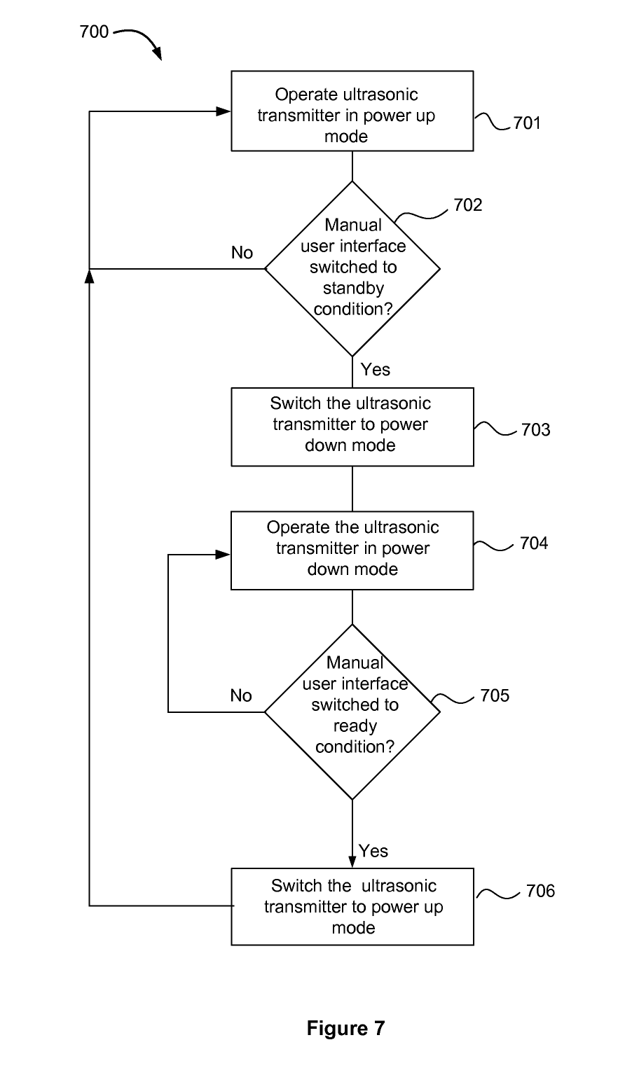

FIG. 7 illustrates a process flow diagram for operating an electronic stylus, according to some implementations. The electronic stylus may be configured to execute the process 700. In some implementations, the controller 118 may be configured to execute the process 700. The process 700 may begin at block 701 with operating the ultrasonic transmitter in the power up mode. At block 702, a determination may be made as to whether the manual user interface has been switched to the standby condition. For example, installation of the stylus cap 402 and/or an actuation of the pushbutton actuator 503 may result in an indication that the manual user interface has been switched to the standby condition. The indication may be received or detected by the controller 118, for example. When the determination at block 702 is that the manual user interface has not switched to the standby condition, the process may return to block 701. On the other hand, if the determination at block 702 is that the manual user interface has switched to the standby condition, the process may proceed to block 703.

At block 703 the ultrasonic transmitter may be switched to the power down mode. In some implementations, the controller 118 may cause the ultrasonic transmitter to be switched to the power down mode. Alternatively or in addition, the manual user interface may include a switching arrangement that is communicatively coupled directly with the ultrasonic transmitter and operative to cause the ultrasonic transmitter to be switched to the power down.

At block 704, the ultrasonic transmitter may be operated in the power down mode. Although the power down mode may include power “off” or zero power modes, in some implementations, the power down mode may be more accurately characterized as a “sleep” or “standby” mode. Thus, in the power down mode the ultrasonic transmitter may be able to receive and respond to signals from, for example, the controller 118, and to rapidly transition to the power up mode.

At block 705 a determination may be made as to whether the manual user interface has been switched to the ready condition. For example, removal of the stylus cap 402 and/or an actuation of the pushbutton actuator 503 may result in an indication that the manual user interface has been switched to the ready condition. The indication may be received or detected by the controller 118, for example. When the determination at block 705 is that the manual user interface has not switched to the ready condition, the process may return to block 704. On the other hand, if the determination at block 705 is that the manual user interface has switched to the ready condition, the process may switch the ultrasonic transmitter to the power up mode (block 706) and return to block 701.

Thus, an electronic stylus having an improved user interface has been disclosed. While various embodiments have been described herein, it should be understood that they have been presented by way of example only, and not limitation. It will thus be appreciated that those skilled in the art will be able to devise numerous systems and methods which, although not explicitly shown or described herein, embody said principles of the invention and are thus within the spirit and scope of the invention as defined by the following claims.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an apparatus as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a stylus, the stylus including:
a nib;
an ultrasonic transmitter configured to transmit an ultrasonic signal; and
a manual user interface, the manual user interface including one or both of:
a removable cap, wherein installing the cap covers the nib and switches the ultrasonic transmitter to a power down mode and removing the cap exposes the nib and switches the ultrasonic transmitter to a power up mode; and
an actuator configured to switch the stylus between a first mode and a second mode, wherein, in the first mode, the nib is in an exposed position and the ultrasonic transmitter is switched to the power up mode; and, in the second mode, the nib is in a covered position and the ultrasonic transmitter is switched to the power down mode.

2. The apparatus of claim 1, further comprising a micro-switch disposed proximate to an external surface of the stylus, the micro-switch being configured to switch the ultrasonic transmitter between the power up mode and the power down mode, wherein installing the cap results in pressing the micro-switch.

3. The apparatus of claim 2, wherein installing the cap results in actuating the micro-switch from a closed position to an open position.

4. The apparatus of claim 2, wherein removing the cap results in releasing the micro-switch from an open position to a closed position.

5. The apparatus of claim 4, wherein the ultrasonic transmitter is configured to transmit an ultrasonic signal when the micro-switch is in the closed position irrespective of whether the nib is in contact with a writing surface.

6. The apparatus of claim 4, wherein the ultrasonic transmitter is configured to transmit an ultrasonic signal when the micro-switch is in the closed position only when the nib is in contact with a writing surface.

7. The apparatus of claim 1, wherein the actuator is a manually operated push button.

8. The apparatus of claim 7, wherein:
a first press of the push button urges the nib into the extended position, and causes the ultrasonic transmitter to be switched to the power up mode; and
a second press of the push button causes the nib to return to the retracted position, and causes the ultrasonic transmitter to be switched to the power down mode.

9. The apparatus of claim 8, wherein the first press of the push button causes the ultrasonic transmitter to start transmitting an ultrasonic signal irrespective of whether the nib is in contact with a writing surface.

10. The apparatus of claim 8, wherein the first press of the push button causes the ultrasonic transmitter to start transmitting an ultrasonic signal only when the nib is in contact with a writing surface.

11. The apparatus of claim 1, further comprising:
a detector arrangement configured to detect an ultrasonic signal emitted by the stylus, the detector arrangement including at least a first acoustic sensor and a second acoustic sensor; and
a computing device configured to determine the position of the stylus based on the detected ultrasonic signal.

12. A method of operating an electronic stylus, the electronic stylus having a manual user interface and including an ultrasonic transmitter, the method comprising:
determining whether the manual user interface has been switched to a ready condition; and
switching the ultrasonic transmitter to the power up mode upon determining that the manual user interface has been switched to the ready condition; wherein the manual user interface includes one or both of:
a removable cap such that removal of the cap uncovers a nib of the electronic stylus and places the manual user interface in the ready condition, and installation of the cap covers the nib and places the manual user interface in the standby condition; and
an actuator configured to switch the manual user interface between the ready condition and the standby condition, such that the actuator, in the ready condition, places the nib is in an extended position; and, in the standby condition, places the nib is in a retracted position.

13. The method of claim 12, further comprising:
operating the ultrasonic transmitter in a power up mode;
determining whether the manual user interface has been switched to a standby condition;
switching the ultrasonic transmitter to the power down mode upon determining that the manual user interface has been switched to the standby condition.

14. The method of claim 12, wherein the ultrasonic transmitter is configured to transmit an ultrasonic signal when the manual user interface has been switched to the ready condition irrespective of whether the nib is in contact with a writing surface.

15. The method of claim 12, wherein the ultrasonic transmitter is configured to transmit an ultrasonic signal when the manual user interface has been switched to the ready condition only when the nib is in contact with a writing surface.

16. An apparatus comprising:
a stylus, the stylus including:
a nib;
an ultrasonic transmitter configured to transmit an ultrasonic signal;
a manual user interface including means for switching the ultrasonic transmitter between a power up mode and a power down mode; wherein the manual user interface is switchable between a ready condition and a standby condition, such that when the manual user interface is switched to the ready condition, the nib is exposed and the ultrasonic transmitter is switched to the power up mode; and when the manual user interface is switched to the standby condition, the nib is covered and the ultrasonic transmitter is switched to the power down mode;
means for determining whether the manual user interface has been switched to the ready condition; and
means for switching the ultrasonic transmitter to the power up mode upon determining that the manual user interface has been switched to the ready condition.

17. The apparatus of claim 16 further comprising:
means for operating the ultrasonic transmitter in the power up mode;
means for determining whether the manual user interface has been switched to the standby condition; and
means for switching the ultrasonic transmitter to the power down mode upon determining that the manual user interface has been switched to the standby condition.

18. The apparatus of claim 16, the manual user interface further including a removable cap, wherein installing the cap switches the manual user interface to the standby condition and removing the cap switches the manual user interface to the ready condition.

19. The apparatus of claim 18, wherein installing the cap results in pressing a micro-switch disposed proximate to an external surface of the stylus, the micro-switch being configured to switch the ultrasonic transmitter between the power up mode and the power down mode.

20. The apparatus of claim 19, wherein:
installing the cap results in actuating the micro-switch from a closed position to an open position; and
removing the cap results in releasing the micro-switch from an open position to a closed position.

21. The apparatus of claim 20, wherein the ultrasonic transmitter transmits an ultrasonic signal when the micro-switch is in the closed position irrespective of whether the nib is in contact with a writing surface.

22. The apparatus of claim 20, wherein the ultrasonic transmitter transmits an ultrasonic signal when the micro-switch is in the closed position only when the nib is in contact with a writing surface.

23. The apparatus of claim 17, wherein the manual user interface includes an actuator that moves the nib between an exposed position and a covered position and switches the manual user interface between the ready condition and the standby condition.

24. The apparatus of claim 23, wherein:
the actuator is a manually operated push button;
a first press of the push button urges the nib into the extended position, and causes the ultrasonic transmitter to be switched to the power up mode; and
a second press of the push button causes the nib to return to the retracted position, and causes the ultrasonic transmitter to be switched to the power down mode.

25. The apparatus of claim 24, wherein the first press of the push button causes the ultrasonic transmitter to start transmitting an ultrasonic signal irrespective of whether the nib is in contact with a writing surface.

26. The apparatus of claim 24, wherein the first press of the push button causes the ultrasonic transmitter to start transmitting an ultrasonic signal only when the nib is in contact with a writing surface.

27. A non-transitory computer readable medium having software stored thereon, the software including instructions for operating an electronic stylus, the electronic stylus having a manual user interface and including an ultrasonic transmitter, the instructions causing the electronic stylus to:
determine whether the manual user interface has been switched to a ready condition; and
switch the ultrasonic transmitter to the power up mode upon determining that the manual user interface has been switched to the ready condition; wherein the manual user interface includes one or both of:
a removable cap such that removal of the cap uncovers a nib of the electronic stylus and places the manual user interface in the ready condition, and installation of the cap covers the nib and places the manual user interface in the standby condition; and
an actuator configured to switch the manual user interface between the ready condition and the standby condition, such that the actuator, in the ready condition, places the nib is in an extended position; and, in the standby condition, places the nib is in a retracted position.

28. The computer readable medium of claim 27, the instructions further causing the electronic stylus to:
operate the ultrasonic transmitter in a power up mode;
determine whether the manual user interface has been switched to a standby condition; and
switch the ultrasonic transmitter to the power down mode upon determining that the manual user interface has been switched to the standby condition.

29. The computer readable medium of claim 27, wherein the ultrasonic transmitter transmits an ultrasonic signal when the manual user interface has been switched to the ready condition irrespective of whether the nib is in contact with a writing surface.

30. The computer readable medium of claim 27, wherein the ultrasonic transmitter transmits an ultrasonic signal when the manual user interface has been switched to the ready condition only when the nib is in contact with a writing surface.
